(19) United States
(12) Patent Application Publication
(10) Pub. No.: US 2007/0282607 A1
(43) Pub. Date: Dec. 6, 2007

(54) System For Distributing A Text Document

(75) Inventors: Peter Howard Bond, London (GB); Roger Henry Keenan, London (GB)

Correspondence Address: BAINWOOD HUANG & ASSOCIATES LLC, 2 CONNECTOR ROAD, WESTBOROUGH, MA, 01581, US

(73) Assignee: OTODIO LIMITED, LONDON (GB)

(21) Appl. No.: 11/579,100

(22) PCT Filed: Apr. 28, 2005
(86) PCT No.: PCT/GB05/01623

§ 371 Date: Jun. 18, 2007

(30) Foreign Application Priority Data
Apr. 28, 2004 (GB) 0409457.9
Apr. 28, 2004 (GB) 0409460.3
Apr. 28, 2004 (GB) 0409461.1
Apr. 28, 2004 (GB) 0409462.9
Apr. 28, 2004 (GB) 0409464.5

(51) Int. Cl. G10L 11/06

(52) U.S. Cl. 704/260; 704/E11.001

(57) ABSTRACT

The invention provides a system for distributing a text document (101) comprising: a data conditioning system (102) including: a data receiver for receiving the text document (101) in a received document format; and a conversion system for converting the text document (101) from the received document format to text data in a standardised text-to-speech format; and a transmission system (105) for transmitting the text data in the standardised text-to-speech format, whereby a receiver (109), including a text-to-speech converter, can be used for converting the text data into speech.

### FIELD OF THE INVENTION

The invention relates to a system and a method for distributing text documents in a standard form for audible consumption. In particular, but not exclusively, the invention relates to the distribution of documents which are provided in a print publication format. The invention also relates to computer software for use therein.

### BACKGROUND OF THE INVENTION

Previous systems for distributing a text document in a print publication format, such as a newspaper publication, to an audio receiver are known, in particular for distribution of such documents to the visually impaired. Systems are known in which a set of volunteers read aloud elements of a publication, their spoken voices are recorded, and the document is re-assimilated and then transmitted in recorded form to the consumers. The recorded document can for example be stored on a recording medium or transmitted to an audio receiver over a transmission medium. However, these systems require a large amount of storage space for acceptable audio quality and use a large amount of bandwidth for transmission.

Methods for synthesising speech from a textual input are known and in common use. Typically, synthesised speech is formed from many combinations of phonemes or wavelets. Many phonemes are common to all spoken languages, but a number are language-specific. A speech synthesis system typically accepts text from an external source, applies sets of rules relating to word pronunciation and sentence construction within a specific spoken language, and then creates a string of wavelets which are output to an audio system which reproduces speech through a loudspeaker.

Systems are known in which data is produced in a format specially adapted for text-to-speech processing. One such format is the DAISY standard, defined by the Daisy Consortium. The DAISY Consortium is establishing an international standard for the production, exchange, and use of the next generation of ‘Digital Talking Books’. The DAISY Consortium is made up of organisations world-wide serving persons who are blind or print disabled.

DAISY receivers are used to produce speech by speech synthesis from a DAISY formatted document. However, formatting documents in the DAISY standard is a complex and specialised task and the navigation of a DAISY document by a user can be complex and time-consuming.

WO-A-01/79986 describes a system in which an information server stores a plurality of text information files for transmission to receiving units, such as in-car entertainment units. The receiving units include a memory card reader or radio receiver which receives and stores the text information files. A text-to-speech browser in the receiving unit generates an audio speech output and receives manual or voice user inputs to allow navigation through the information. The text information files are transmitted in a format originally intended to be a display format, in particular Web pages, which are often not particularly suited for output as speech. Speech markup tags are added in the receiving unit to assist in speech reproduction. However, the lack of access for manual intervention in specifying how a particular article should sound, or for setting rules which relate to a particular publication, limit the control of quality of spoken output that can be achieved.

U.S. Pat. No. 5,815,671 describes a system for delivery of entertainment programs to a receiver system for storage and subsequent retrieval by a subscriber. The program material is selected by the user in non-real time from a menu corresponding to a set of subscribed services. Some of the data that is received may be in alphanumeric form and may be converted to audio at the receiver by speech synthesis. U.S. Pat. No. 5,524,051, U.S. Pat. No. 5,590,195 and WO-A-03001685, all in the name of the same applicant, describe similar systems.

These describe a specific menu-based receiver using digitally-encrypted data from FM sidebands.

Of the systems that are known, many use a “Talking Book” structure to present the spoken content to the user, where the information is presented in an essentially “flat” way for the user to access it sequentially. Other known systems, such as those set out in U.S. Pat. No. 5,815,671 and related patents above, present a menu-based or hierarchical set of controls to the user. None of these deliver an experience to the user which is easy and intuitive to use when the users mind is not wholly occupied with using it, for example when the user is simultaneously occupied in driving a vehicle.

Numerous systems allow for conditional access to electronically transmitted information. For example, patent document EP0491068 discloses such a system for real-time selective control of data broadcasting to personal computers, patent document WO01/33851 discloses the addition of a conditional access system to a broadcast through an unused identifier reserved for security data, and patent document EP0696141 discloses a method of transmitting decryption keys in an encrypted form in a conditional access system sending video, audio and data services.

When a one-to-one communications path in both directions can be established between the setter of the conditions and the user, great flexibility can be achieved and ease of use can simultaneously be high. Examples of such systems are password control within computer systems and conditional access to web sites. Where there is a single source of the information to be accessed and many receivers of the information, none of which can establish unique two-way communication paths with the source of the information, there are fewer known systems. Such situations occur, for example, in broadcasting where there are few information transmission sources, but many identical or similar information receivers, none of which is able to communicate with the transmitter. A further example is information electronically stored and distributed on CD-ROM or any other mass storage device. If all of the information is intended by the owner of the information to be freely available to everyone under all conditions, then no selective access is required by the owner of the information. However, if the owner of the information requires some or all of the information to be available only subject to certain conditions, such as the payment of a fee, then a means must be implemented whereby all users can receive all of the information, but can only access those parts of it for which they have satisfied the conditions set by the owner of the information. Where each receiver can be individually identified, solutions are known which involve transmitting the access conditions to the individual receiver. Where all the receivers are identical, as will often be the situation where receivers are mass-produced, known methods include the use of keypads to enter information for setting of conditional access, smartcards or electronic keys which can be purchased or supplied by post to define selective access conditions.

Many of these known methods require potentially expensive equipment at the receiver, or expensive production and support methods where every receiver is made to be different from every other, for example by including an electronic serial number. In many cases, such as a receiver in a mass-produced motor vehicle, implementations requiring extra equipment are impractical. Effective systems which are also economically attractive must not add significantly to the cost of the receiver, must be simple to operate, must be secure against fraud and must be operationally robust, so that access is provided only when the access conditions are satisfied and any dependent conditions, such as payment, are applied only when access has been successfully granted. A system, used for the purchase of beverages from a vending machine, is disclosed in U.S. Pat. No. 6,584,309. It involves the use of a mobile telephone receiving a vend code from a server and sending the same vend code to a beverage vending machine by a radiofrequency code, an audible tone code or a manual code. Such a system is vulnerable to fraud, since a valid vend code can be duplicated, and to consumer dissatisfaction, as payment is taken before the vend code is issued. Whilst suited to a low-value purchase, such a system is unsuited to control variable-value on-going conditional access to electronic information.

### SUMMARY OF THE INVENTION

In accordance with a first aspect of the present invention, there is provided a system for distributing a text document comprising:

a data conditioning system including:
a data receiver for receiving the text document in a received document format; and
a conversion system for converting the text document from the received document format to text data in a standardised text-to-speech format; and

a transmission system for transmitting the text data in the standardised text-to-speech format,

whereby a receiver, including a text-to-speech converter, can be used for converting the text data into speech.

The system receives documents from one or more existing print publication processes and from one or more different publishers. The data conditioning system is preferably adapted for converting the documents having a plurality of different document formats to text data in a standardised text-to-speech format. The system then creates an output file in a standardised format which is ready for onward transmission to one or more receivers, each receiver including a speech reproducing system and control system allowing user to navigate through the received document.

Preferably, the system is adapted to receive documents in one or more print publication formats such as a page layout file formats, and to covert documents from the one or more page layout file formats to the standardised text-to-speech format.

In accordance with a second aspect of the present invention, there is provided a method of distributing a text document, comprising the steps of:

receiving the text document from a print publication process;

converting the text document to converted data in a standardised format, the conversion process comprising inserting markup for assisting navigation between parts of the document when said parts are output as speech; and

transmitting the converted data in the standardised format,

whereby a receiver, including an audio output device, can be used for outputting the converted data as speech and for navigating between said parts of the document when those parts are output as speech.

Further aspects of the invention are set out in the appended claims, and further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic illustration of a system for distributing a text document in accordance with an embodiment of the invention.

FIG. 2 illustrates a further embodiment, similar to the system of FIG. 1.

FIG. 3 is a schematic illustration of a conditional access system in accordance with an embodiment of the invention.

FIG. 4 is an illustration of a system for controlling the delivery of speech synthesised text in accordance with an embodiment of the invention.

FIG. 5 is a schematic illustration of a compliant dictionary system in accordance with an embodiment of the invention.

FIG. 6 is a schematic illustration of a data conditioning system in accordance with an embodiment of the invention.

### DETAILED DESCRIPTION OF THE INVENTION

It should be understood that the sphere of the invention is the field of data processing and data transmission; in this regard it should be understood that all of the components of the embodiments of the invention described below are embodied using data processing equipment, in particular computing equipment, and data transmission equipment such as radio transmitters and receivers.

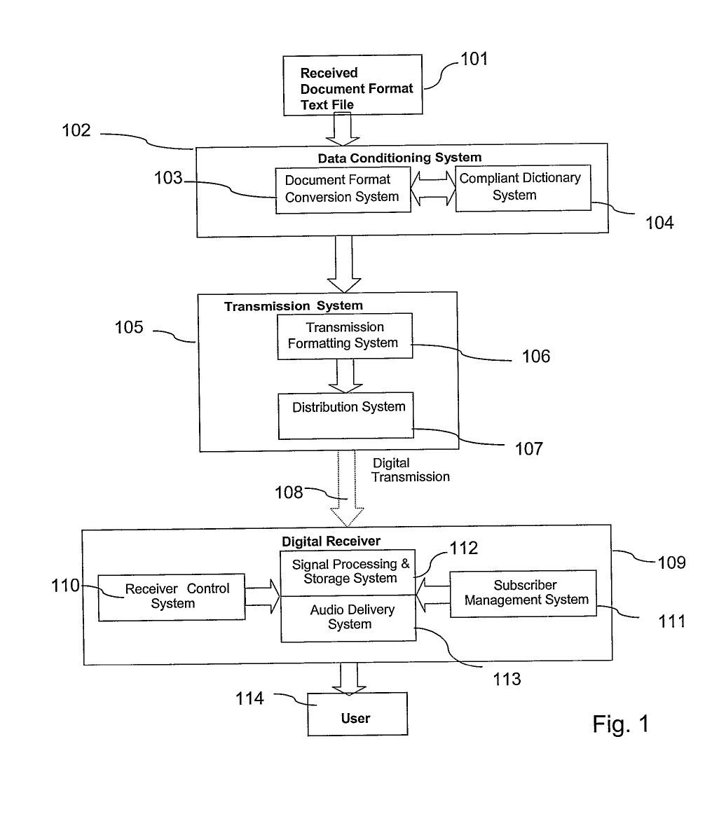

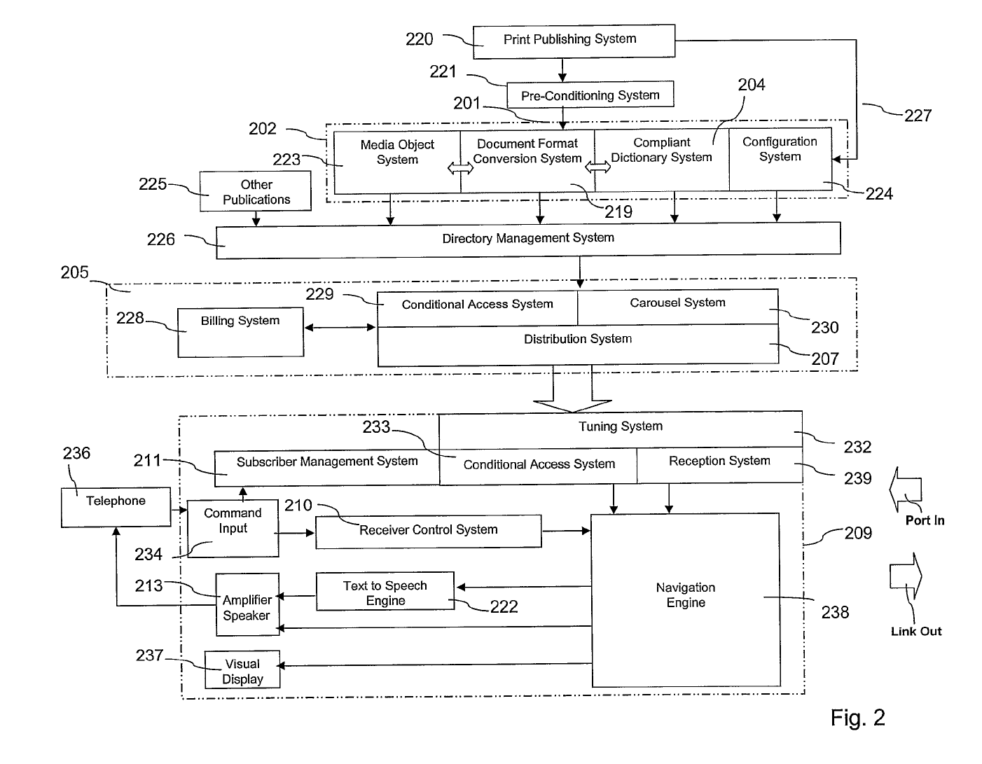

FIG. 1 is a schematic illustration of a system for distributing a text document in accordance with an embodiment of the invention, which may be combined with each or any of the systems described in relation to FIGS. 2, 3, 4, 5 and 6 below.

An important aspect of the invention is in the ability to distribute printed publications, e.g. the structured content of a newspaper or a magazine provided by a publisher, to people in a situation in which it is not convenient to read a printed publication, whilst providing a navigable structure which is different than, but related to, the original structure of the printed publication.

The speech output system of the invention can use as original source material page layout information files of printed publications. Typically, the page layout information files will be received in an eXtensible Markup Language (XML) format, or a proprietary format such as the Adobe InDesign™ page layout file format.

XML is a method for tagging text in a document so that its components can be distinguished and reused in another computer application. XML is an open standard developed by the World Wide Web Consortium (W3C). Tags are used to label information and associated attributes can be used to control the positioning of the elements on the printed page. A tag can be used to describe the role of the item. For example, to indicate that a particular sequence of words is a headline element in a text flow, it may be labelled with a tag that describes its contents: <Headline>. XML tags are extensible, and many publishers use their own custom set of tags in their own proprietary page layout file format.

A single edition of each publication, for example a daily newspaper or a weekly magazine, is received as a page layout file, which is referred to further as a text file, although typically the page layout file will also include elements other than text, such as photographic images and graphics. After the text file 101 is received by the data conditioning system, the conditioning system can reduce the amount of data in the page layout information file by discarding non-textual information such as images, etc, to leave a pre-conditioned text file.

The data conditioning system 102 comprises a document format conversion system 103 and a compliant dictionary system 104. The document format conversion system 103, referred to as a first converter, is adapted for converting the pre-conditioned text file to a text file in a standardised format ready for distribution to a set of receivers. The document format conversion system 103 structures the document by inserting a series of markup tags in the pre-conditioned text file according to a set of rules, some of which are common to different publications handled by the conditioning system and others of which are customized and specific to the publication being conditioned. The markup tags are typically inserted by identifying parts of the original text file from characteristics of the text file, including its original markup tags, removing the original markup tags and inserting the tags around the relevant parts of the text. The mapping between the original content and the conditioned text file is determined by the rules applied in the document format conversion system 103.

In a preferred embodiment of the invention, the inserted markup tags include page tags <OPage> and title tags <OTitle> which identify respectively a specific page of a publication and its title such as “Front Page” or “Sports Page”. The inserted markup tags also comprise article tags <OArticle> which identify the articles on a specific page, headline tags <OH> which represent the headline of a specific article and paragraph <OP> tags which represent the paragraphs of a specific article. The conditioned text file structure will typically be significantly simpler than the original text file structure, since the text file is being conditioned for playback via speech output. As such, the navigational structure of the conditioned text file should be both standardised, so that different publications can be navigated using a common set of navigational commands in each case, and simplified, so that the set of navigational commands can be reduced to a simple basic set. In preferred embodiments of the invention, the conditioned text file has a vertical and horizontal navigational structure. Vertical navigation involves navigating from a page level in the document to an article level, respectively. Horizontal navigation involves navigating from one page to the other, from one article to another. Preferably, the number of vertical navigational levels below the page level is limited to only two levels or less, including an article level and an intra-article level. An article may include various components at the intra-article level, including a headline, and one or more paragraphs, which may be navigated between using vertical navigation controls. It is intended that the document will be able to be horizontally navigable at the article level, by playback of the headline components alone.

As an example, the above-mentioned markup tags are added to a text file representing the front page of a publication. The front page in this example includes two articles having respectively two and three paragraphs. This page is marked up in the conditioned text file as follows:

<OPageid=“001.001.0001.01.382032.0135.2.00.001”>

<OPTitle>Front Page</OPTitle>

<OArticle>

<OH>The headline of article 1</OH>

<OP>The first paragraph</OP>
<OP>The second paragraph</OP>

</OArticle>
<OArticle>

<OH>The headline of article 2</OH>

<OP>The first paragraph</OP>
<OP>The second paragraph</OP>
<OP>The third paragraph</OP>

</OArticle>

</OPage>

The inserted markup tags may also comprise tags indicating the publication title, the author name, a short article brief or a link to a reference cited in a page or article.

The document format conversion system 103 is governed by both generally applicable rules and publication-specific rules. General rules may be customized to provide publication-specific conditioning rules. The publication specific rules can be defined by interacting with a rules definition interface for the document format conversion system 103. Each publication-specific conditioning rule has a set of attributes, which define:
1. The identity of the page(s) in the original text document to which the rule is to be applied. For example, the rule may be applied only to the current page, all pages of the document or a specified page such as the front page of the original text document.
2. The characteristics of one or more articles in the pages identified in (1) above to which the rule is to be applied. For example, the rule may be applied only to a specific item, all articles on the page, or specified items identified by numbering on the page or position on the page.
3. The edition of the publication to which the rule is to be applied. For example, the rule may be applied only once, i.e. to the current edition, to every edition or only to specified editions such as the Monday edition.

Both the general and publication specific rules can include:
1. Page concatenation rules. In order to reduce the number of pages in the conditioned document, and thereby to make the conditioned document more conveniently navigable, page concatenation rules can be defined whereby two or more predefined pages in the original text file are combined to form a single page in the conditioned text file.
2. Page titling rules. A page title is added automatically to each page, whether concatenated or not, in the conditioned text file. A default page title is defined as text derived from the page title and the page number in the original text file, for example “International News Page Three”. However, the page title can also be manually edited.
3. Headline concatenation rules. The original text file may have multiple headline elements associated with an article. A headline concatenation rule defines the way in which text elements from the multiple headline elements are concatenated into a single headline in the conditioned text file. The original headline types may be defined using headline type definitions, using parameters such as one or more of associated markup tags, location on the page, font size, etc. A defined order of concatenation may be provided for the different headline elements, as identified by headline type.
4. Text removal rules. These rules define those text elements in the original text document. Text element identities or types may be defined using text element identity or type definitions, using parameters such as one or more of associated markup tags, location on the page, font size, etc, and the identified text element or elements may be deleted from the text file. For example, defined headline elements (such as “by lines” may be deleted from the text document.
5. Text insertion rules. For example, a predefined text element may be added at the start of a predefined article headline type or set of article headlines.
6. Article ordering rules. The article ordering rules map the articles in the original text document which are located in various positions over one or more pages in the original text document and not ordered in a single linear sequence, into a linear sequence. Article identities or types may be defined using article identity or type definitions, using parameters such as one or more of associated markup tags, location on the page, font size, etc, and the identified articles or article types may be ordered in a predefined linear sequence. The articles are thus added in a single linear sequence in each page of the conditioned text file, in order to provide a simplified and standardised navigational structure at the article level.
7. Pronunciation guideline rules. These rules may be used to insert pronunciation guideline tags at or around predefined elements of the text document. These rules may be used to govern the way in which the pronunciation guideline tags are added to the text file. In this way, particular parts of the text may be pronounced differently depending on the publication. For example, a publisher may want to pronounce a quoted phrase differently by either changing the pitch of the voice or by mentioning the words “quote” and “unquote”. Markup tags such as <emphasis>, </emphasis> or <quote>, <unquote> may in that case be added to the text file, by use of publication-specific rules identifying the relevant patterns in the original text file and defining the way in which the markup should be added.

Rules are thus defined which relate to the way in which the original text content is converted to the conditioned text content.

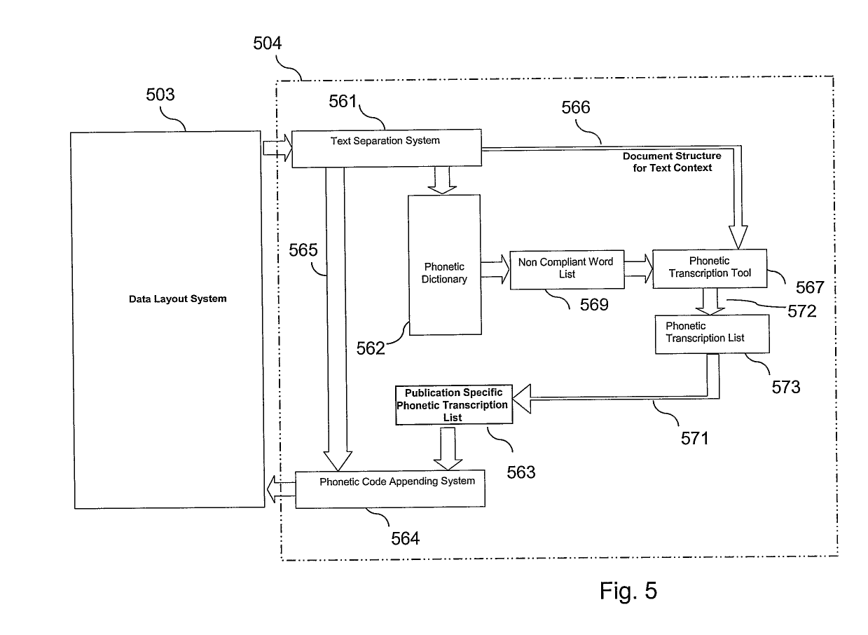

The document format conversion system 103 may also interact with a compliant dictionary system 104 for forming phonetic code pertaining to the conditioned text content. The compliant dictionary system 104 will be described in greater detail below in relation to FIGS. 2 and 5. Phonetic transcriptions are provided for particular words in the text file which are not held in a compliant dictionary. The word would be marked up with a specified tag, such as <OLEX ref=“384”> Maastricht</OLEX> which identifies a corresponding record in a lexicon file which provides the phonetic code. Such a lexicon file is added to each conditioned text file, if non-compliant words are found in the original text file material. The phonetic code is preferably in the form of an International Phonetic Alphabet (IPA) Unicode phonetic transcription, which is a standard phonetic code format understood by most text-to-speech engines.

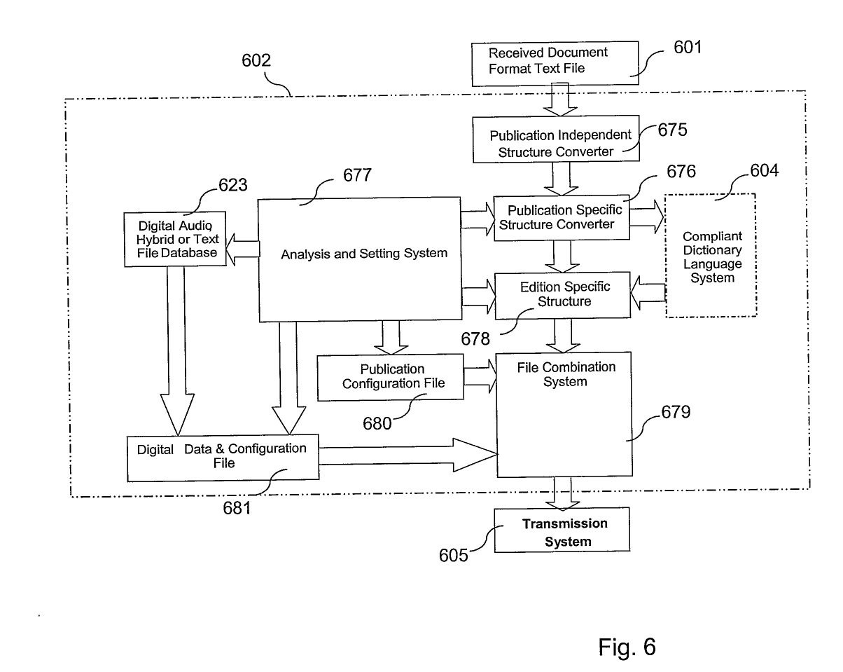

The data conditioning system 102 may be used to add digital audio, or hybrid audio/text files to the original text file, for example audio jingles or advertisements. The data conditioning system 102 may also be used to insert overriding or near real time information such as “news flashes”. The data conditioning system 102 will be described in greater detail in relation to FIG. 6. The data conditioning system 102 outputs data, such as tagged text and audio data, in a standardised format which complies with a complete set of standard rules and which is then transferred to a transmission system 105. The transmission system 105, which comprises a transmission formatting system 106 and a distribution system 107, prepares the data in the standardised format to ensure reliable and secure transmission over a digital transmission system 108. The digital transmission system 108 may be one or more of a terrestrial radio broadcast system, a satellite radio broadcast system, a cellular radio system, and other terrestrial transmission systems such as Wi-Fi and Wi-Max radio transmission systems and fixed line transmission systems such as fixed line Internet links. Indeed, the transmission channel may use any electronic or electro-optical transmission method, including but not limited to reception of modulated electromagnetic radiation, for instance radio or television transmissions, reception of un-modulated electromagnetic radiation, reception by direct connection to a device transmitting analogue electrical information, reception by direct connection to a device transmitting digital electrical information, reception from a digital network, reception of modulated light or infra-red light, reception from a storage device, such as an optical disc, memory stick or other removable storage device.

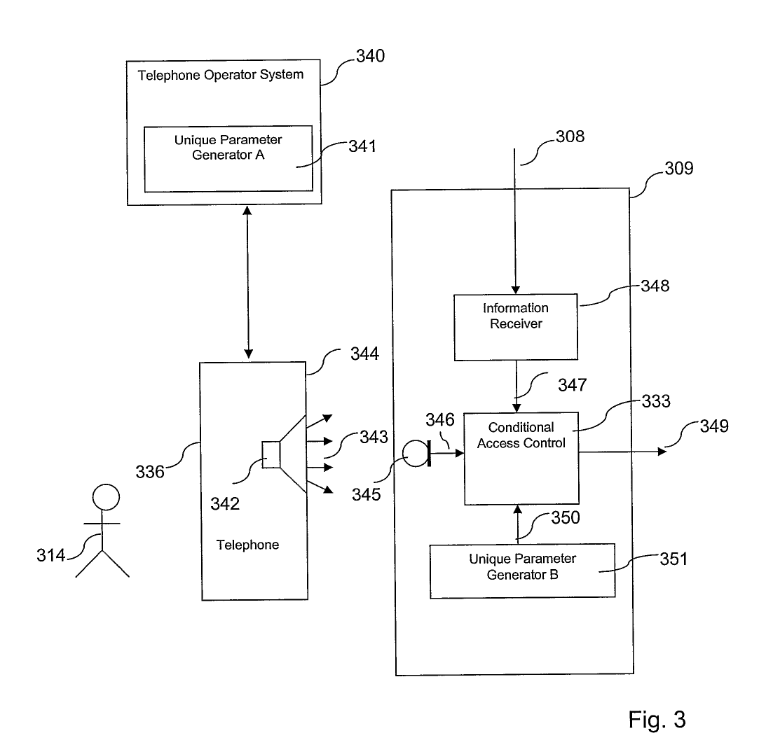

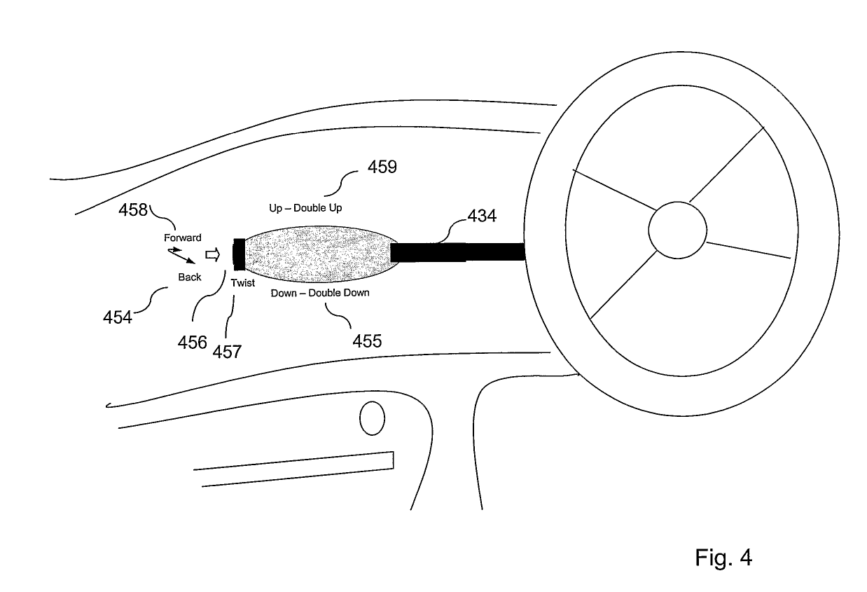

The transmission formatting system 106 compresses and/or encrypts the data and inserts redundancies and error correction code such that the data has a “wrapper” which makes it ready for transmission in a digital form. The data is then fed to a distribution system 107 which conveys the data in the above standardised format to a transmitter (not shown). Within the distribution system 107, there may be subsystems defining such characteristics as repeat and refresh rates for data transmission. The transmitted data is then received by a receiver 109, such as a digital radio receiver, which comprises a text-to-speech (TTS) system for converting the received text data to speech. The received data is “unwrapped” and stored in a memory of the receiver using a signal processing and storage system 112. The received data may be decompressed and/or decrypted before being stored in the memory or after being extracted from the memory. The receiver comprises a subscriber management system 111. Access to the stored information is provided only if authority is granted by the subscriber management system 111, which will be described in greater detail in relation to FIG. 3. This subscriber management system 111 determines if a system user 114 had the right to receive access to a particular publication stored in memory on the receiver. The system user 114 is able to select the text reading service using the receiver control system 110 which will be described in greater detail in relation to FIG. 4. The receiver control system 110 may be operated by voice or manually. The receiver control system 110 uses a set of simple standardised commands that can interact with the tags inserted in the text by the document format conversion system 103. The commands allow a user to navigate to a desired item, e.g. the next paragraph or a next headline for instance in a publication. The received data is extracted from the memory of the receiver by the control system 110 and delivered as speech by the audio delivery system 113, referred to as a second converter, which is preferably a TTS system, and which converts received text data into speech in accordance with the tags embedded in the received data. The system user 114 is thus able to hear the publication read out using the receiver.

The system is described above in relation to a text document which is distributed to a receiver, but it should be understood that the system relates to a system in which a plurality of publications are heterogeneously processed, using publication-specific rules, using the conditioning system, and transmitted to a large number of receivers by means of a common broadcast channel. The system may generate data from a multiplicity of documents or publications in different electronic formats. The documents may have a plurality of print publication formats which are each converted using different rule sets to data in a standardised format. The system then creates an output file in a standardised format which is ready for onward transmission to various receivers, each receiver including a non-visual document reproducing system and control means for a user to navigate in the received document.

FIG. 2 illustrates a further embodiment, similar to the system of FIG. 1, which may be combined with each or any of the systems described in relation to FIG. 1 above and FIGS. 3, 4, 5 and 6 below.

In this embodiment, the system for distributing a text document to a receiver 209 comprises a data conditioning system 202 for conditioning the data in a document to data in a standardised text-to-speech format, a transmission system for transmitting the data in the standardised format. The transmission system includes a transmission formatting system 206 associated with the transmitter.

The process of distributing a text document starts with one of a plurality of publishers, represented here by a single publisher 220 but it should be understood that the system takes inputs from a plurality of different print publication processes or from non-print processes or sources. The print publication processes involved typically include newspaper and/or magazine and/or journal publication processes. Every publisher is different and operates in a different way. In the system, a computer may be installed at the publisher's premises site, to receive the page layout file of a publication after it has been completed for publication in print format, and to transmit the file to the data conditioning system 202.

Different publisher use different publication page layout file formats which may include different document formats such as an XML document format or formats and/or Portable Document Format (PDF). In some cases it may be appropriate to preprocess the page layout information of a publication on the publisher's premises by removing graphic images which are not required in the system of the invention; in other instances, it may be appropriate to transmit the entire publication for processing. Whatever format the page layout information of a publication is delivered in, it is received and processed in the pre-conditioning system 221 into a standard format text file 201, preferably an XML document format. The format contains additional page layout information, which will be used during a conditioning process to establish how the converted document will be structured, in particular how the navigation around the publication will work when the document is read out using a text-to-speech engine in a receiver. Some of the additional page layout information may be removed during the conditioning process.

The function of the data conditioning system 202 is to convert the print publication format document into data in a standardised text-to-speech format, such as text files in a markup language which is suitable for the interpretation by a TTS engine 222 in receiver 209. The data conditioning system 202 adds a series of descriptive tags to the text data using a document format conversion system 219, which operates in a similar fashion to document format conversion system 103 described in relation to FIG. 1. Although the bulk of the information transmitted through the system is in text, media objects may be inserted to the data in the standardised format using the media object system 223. These might typically be short news flashes or audio jingles or advertisements in MP2, MP3, MP4, GIF or JPG format for instance. There may be provisions within the data conditioning system 202 for software updates of the receiver.

The data conditioning system includes means for forming phonetic code pertaining to the text data. The TTS engine 222 of the receiver 209 may be equipped with a phonetic dictionary containing most of the words in the relevant language. However, there are exceptions to the content of the dictionary, a new or unusual word or a new or unusual place name for instance. The pronunciation of a word may be different in different languages and may even be different between different publications. New words are dealt with by the data conditioning system 202 by using a compliant dictionary system 204 which will be described in greater detail in relation to FIG. 5. The receiver may contain a compliant dictionary identical or similar to the compliant dictionary in the compliant dictionary system 204. Using the compliant dictionary system 204, the data conditioning system identifies words, referred to herein as non-compliant words, within the extracted data for which a phonetic code is not present in the compliant dictionary system 204, and adds a phonetic transcription in a universal format such as IPA Unicode format for such words to the text file. The phonetic code may be generated using a phonetic transcription tool which allows an operator to create a phonetic transcription of a non-compliant word. Alternatively, the phonetic transcription can be looked up in a phonetic master dictionary, which may be stored on a remote central server. The compliant dictionary system 204 may also be used to add other language related data to improve pronunciation, in the form of a lexicon file including a set of document language rules. The data conditioning system comprises an appending system for adding the phonetic code to the text data.

The added phonetic code may relate to the non-compliant words of the text data only, for instance in the form of a document-specific phonetic dictionary, which is then transmitted to the receiver 209. The receiver is capable of accurately producing the compliant words from a copy of the compliant phonetic dictionary in its memory and looks up the phonetic transcription of the non-compliant words from the appended phonetic codes in the received data. This ensures accurate phonetic synthesis of all the words of the transmitted data received by TTS engine 222 of the receiver 209.

The configuration system 224 may include a configuration file containing configuration information in the transmission. The configuration file contains general information about a publication, i.e. title, days of issue, and pointers to all of the pages contained within the publication and their interrelationship with each other and with any media objects which may have been included. The configuration file describes the structural division of the content of the publication according to the publisher's decision and may associate each edition of the publication with regional information. The configuration file also provides voice information specific to the publication.

Each publication has a unique publication number. The object number references it and is associated with a configuration file and possibly a document-specific phonetic dictionary and/or media objects. Each publication is transmitted to a directory management system 226 which gathers all the publications from different feeds 225 which are to be transmitted to one or more receivers. The directory management system 226 organizes the publications and indexes them into the order and method in which they are to be transmitted using the transmission system 205.

The transmission of a publication, which has been processed to create text data in the standardised format, may require legal and editorial approval from the publisher 220 before it is transmitted. There is therefore a link 227 from the data conditioning system 202 to the publisher 220 so that the publisher, who may require responsibility for the content, can review the conditioned document, edit the content and provide signoff prior to transmission of a publication.

There is a variety of ways in which the information can be transmitted to the receivers 209 using the distribution system 207 and transmitter (not represented). It is preferably a one to many broadcast transmission, the transmitter being preferably a broadcast transmitter. Alternatively, the transmission may be conducted using digital audio broadcasting, the transmitter being preferably a digital broadcast transmitter, such as the “Eureka 147 Digital Audio Broadcasting (DAB)” system operating in many parts of the world or the in-band on-channel (IBOC) used in the United States. The transmission may also be conducted using a mobile telephony system such as a 3G or GSM cellular radio system. The transmission may also be conducted using satellite radio, shortwave radio or any other mechanism which is appropriate for communicating a data file to a receiver.

The transmission system 205 may include a billing system 228 and an associated conditional access system 229. The user has access only to those publications for which he has subscribed. The billing system 228 and conditional access system 229 provide information to the receiver of which publications the user has subscribed to and paid for, and for which he is therefore allowed access.

There may also be a carousel system 230 in the transmission system 205 which provides common scheduling for the transmission of a plurality of different publications, with different publications being transmitted in sequence. The carousel schedules each publication to be transmitted on a repetitive basis. This is advantageous in that it avoids problems of transmission coverage, for example the problem of a receiver in a car which is parked in an underground car park overnight. By frequently and repeatedly transmitting the same content, a receiver which has been out of coverage will within a short time after entering a coverage area receive the full set of content. The carousel can have a repetition frequency or schedule defined individually for each publication, and different publications may have different average frequencies of repetition. Preferably, therefore, the most frequently repeated content is transmitted with a frequency of less than every ten minutes, more preferably less than every two minutes. However, other content may not be so time-critical and can be transmitted on a less frequent basis, for example not more than once an hour. The frequency of repetition within the carousel system 230 is defined as a balance between cost and the service level to be provided. The transmission system has mechanisms for handling data objects, for multiplexing them, for compressing them and for error handling.

The receiver may be installed as an original equipment manufacturer component in a motor vehicle or may be retrofitted as an aftermarket component. The receiver system comprises a tuning system 232 to receive the signals, which include data in the standardised format, transmitted by the transmission system 205. The tuning system 232 may include some mechanism where it can receive transmissions when the vehicle is not powered. This is advantageous in that publications may be delivered overnight and received into a vehicle, so that they are available when the vehicle first drives off. To achieve this, the receiver may include a mechanism of advance notification, so that the receiver is switched from standby mode to active mode on receipt of an advance notification which is sent prior to the transmission of data to be received or say every five minutes to notify what is being transmitted in the following interval, in order to keep the standby quiescent power consumption of the receiver 209 to a minimum.

The receiver selectively stores and receives file under the control of the conditional access system 233. Once the compressed data files have been received by the tuning system 232, they are stored in the reception system 239 in compressed and encrypted form. They may be extracted from storage when required for listening to and decrypted and decompressed on-the-fly, or stored in a decrypted or decompressed format. The conditional access system 233 is in one embodiment implemented with a telephone 236 for instance and will be described in greater detail in relation to FIG. 3. The text files are read out to the user using for instance a TTS engine 222. There may be an option for pluggable voices in relation to the TTS engine 222, allowing a user to exchange a first voice for a different, second voice used in the speech synthesis. The user may select the sex, accent and type of voice he would like to listen to. The speed of the speech may also be selected by the listener. The user may control the navigation through the spoken pages using a command input 234. The command input may be an automatic speech recognition device allowing a user to use spoken commands to move around the pages. Alternatively, the command input 234 may be a manual control unit, for instance clamped to or built in to the steering wheel of a vehicle. Additional switches or buttons may be provided on the front of the receiver unit, for example to control the volume of the synthesised speech. The manual control unit may alternatively be a combination of control stick, for example steering column mounted, and receiver buttons. These commands are transformed into standard commands by the receiver control system 210 and then relayed to a navigation engine 238. The navigation engine 238 may control the TTS engine 222 using the Speech Application Programming Interface (SAPI), and forwards a text stream to the TTS engine 222, in Speech Synthesis Markup Language (SSML) format. In vehicle applications, the vehicle's existing amplifier 213 in the car radio and loudspeakers may be used to output a speech to a user. The navigation engine 238 also forwards audio files directly to the amplifier 213, in MP2, MP3 or MP4 format for instance or as Dual Tone Multiple Frequency (DTMF) tones. Optionally, the text, or elements of text related to the text currently being speech synthesised, may additionally be displayed on a display on the receiver.

An important application of the system of the present invention is the processing and delivery of mass market publications, which have already been prepared for print, as an adjunct to delivery of the content via print.

A preferred embodiment provides “port-in” functionality to the receiver, whereby the receiver is capable of receiving text data in the standardised text-to-speech data format from a transmission channel which is different than the main transmission channel. Such a file may for example be transmitted to the receiver using cellular radio technology. As a specific example, an aircraft engine manufacturer may wish to deliver maintenance manuals electronically to a fitter, who may not, temporarily, be able to read publications. In this situation, there may be a special version of the manuals prepared for distribution. Also, an organization wishing to communicate with many of its delivery drivers or salespersons may prepare a special publication, which would never appear in print form, for distribution to the drivers via the vehicle radio/receiver. The data may be sent to the receiver by email or otherwise downloaded by the receiver in an audio or text format consistent with the standardised text-to-speech data format.

The data conditioning system also comprises means for adding a “link-out” tag to the data in the standardised format, the link-out tag providing a navigation command to the receiver for including information received via transmission channel which is different than the main transmission channel. This may be referred to as a backchannel “link-out”, and may be performed over a two-way link such as a cellular radio link or other wireless link.

The receiver may include link-out information derived from data in a format not requiring speech synthesis. For instance, a user may choose, via a navigation command and possibly within a time window, to listen to an interview that was mentioned in an article being read. The interview may be delivered in the form of an audio or text file which is requested and delivered to the receiver via the backchannel link. Similarly, a user listening to a textual music review could click on a link, conduct payment authorisation, and receive the actual music track, as an audio file. The backchannel “link-out” could also be used to deliver content derived from the text data file received via the main transmission system to remote third parties.

In a preferred embodiment of the invention, the receiver comprises a conditional access control for selective access to received data. For conditional access system to operate correctly, it is necessary to form an association between a unique identity of the receiver with a subscriber record in the transmission system, so that the conditional access system can identify the correct receiver associated with a particular user, and for changing such association when the ownership of the receiver changes. In preferred embodiments of the invention, such association is performed using a mobile telephone link. The mobile telephone link may also, or alternatively, be used to modify individual access conditions allowing a user to access selectively information within received electronic transmissions or from electronically recorded information.

FIG. 3 is a schematic illustration of an embodiment of a conditional access control system for use in the text document distribution system of the invention, and may be combined with each or any of the systems described in relation to FIGS. 1 and 2 above and FIGS. 4, 5 and 6 below.

In this embodiment, the system uses an input device 336 for transmitting control information to and/or from an operator 340 in order to establish an association between a unique identity associated with the receiver with a subscriber record in the transmission system, or to modify selective access conditions within the receiver 309. The receiver 309 receives text data in a standardised text-to-speech format over a digital transmission channel 308, as described above in relation to FIGS. 1 and 2.

The user 314 uses a conventional or mobile telephone or a similar portable communication device, or a computer linked to the Internet, as the input device 336 to make contact with a telephone operator 340. In the preferred embodiment, the input device 226 is a mobile telephone. The user and the telephone operator can be both humans and communicate by voice using the mobile telephone in a conventional manner. Alternatively, either the user 314 or the telephone operator 340, or both, are replaced by automated electronic processes. The contact may be initiated by the user or the telephone operator or automatically. The user and the telephone operator interact to define and agree subscription entitlements to which the user is obtaining access, conduct payment authorisation, etc. The receiver 309 contains a means 348 of receiving the information received from the transmission path 308. The received information 347 is then fed to a means 333 of selectively allowing access to all or parts of the received information, by means of decryption keys associated with the one or more publications to which the user is entitled access according to the subscription entitlements stored in the subscriber record. The one or more publications are then output as audio signals 349 as described above in relation to FIGS. 1 and 2.

Associated with the conditional access control 333 is a microphone 345. On completion of the transaction between the user and the telephone operator 340, the user places the mobile telephone 336, which contains a loudspeaker 342, in front of the microphone 345. The telephone operator 340 causes the loudspeaker to emit a series or stream of audible tones, such as DTMF tones conveying the control information, which are carried by sound waves 343, to the microphone 345, and sent as electrical signals 346 to the means of conditional access control 333. The means of conditional access control interprets the control information signals as encrypted or coded commands. These commands may be used to program a unique identity in the receiver and/or to set or modify the conditions of access defining the selection 349 and implements any instructed changes to the access conditions. Encryption of the tone stream prevents unauthorised change, and confirmation of successful completion ensures that actions, such as completing payment, which are dependent upon successful completion, are only implemented if successful completion has been confirmed.

In one embodiment, the apparatus controlled by the telephone operator contains a first generator 341 for generating a parameter which is unique, and which is transmitted to the information receiving device within the tone stream 343 as an individual part of the tone stream or coded or encrypted within it. The information receiving device contains a second generator 351 for generating an identical unique parameter, which is fed electronically 350 to the conditional access control 333 which then compares the independently generated unique parameters. Access will be granted if the two unique parameters satisfy a predetermined requirement. The first and second parameters can be specific for the receiver and can be dependent on the time of obtaining the control information.

The first and second parameters may be a digital certificate, an identification number or the date and time of day. For the last, the internal clocks of the telephone operator apparatus and the receiver do not have to be strictly synchronous as a time window may be set. Changes to the access conditions are permitted only if the two unique parameters match within certain preset tolerances. Preferably, when a change of a status of access conditions has been completely and successfully implemented, the receiver provides an indicator to inform the user and, possibly, the telephone operator. The indicator may be a spoken message. The user may be informed by other means, including but not limited to, a visual or audible indicator. After a successful change of the status of access conditions, the operator may be arranged to issue a payment command.

In a further embodiment, the coded signals sent from the operator system 340 via the mobile telephone link provide a unique code for the receiver 309. This unique code may be used to define a shared secret encryption key, which only needs to be programmed into the receiver once during the lifetime of a subscription. The transmission system can use this shared secret key to encrypt decryption keys associated with the one or more publications to which the user is entitled access according to the subscription entitlements stored in the subscriber record. The transmission system can then broadcast the encrypted decryption keys such that, even though many receivers can receive the broadcast data, only the receiver which holds the shared secret key can access the broadcasted decryption keys and thereby provide its user with access to the appropriate content.

In a yet further embodiment, the coded signals are sent via the mobile telephone link from the receiver 309 to the operator system 340. The receiver can be provided with its unique identity at the time of manufacture. The receiver would then communicate its unique identity by means of the mobile telephone uplink to the operator system 340, where it can be associated with the subscriber record. This unique identity may be used by the operator system to look up a shared secret encryption key, which is also stored in the receiver. The transmission system can use this shared secret key to encrypt decryption keys associated with the one or more publications to which the user is entitled access according to the subscription entitlements stored in the subscriber record. The transmission system can then broadcast the encrypted decryption keys such that, even though many receivers can receive the broadcast data, only the receiver which holds the shared secret key can access the broadcasted decryption keys and thereby provide its user with access to the appropriate content.

In an alternative embodiment the receiver 309 has a unique identity or code which can be provided by inserting a card, such as a smart card, in the receiver. The advantage of this solution is that the card is replaceable if the system is compromised. However, this solution requires a card reader and a slot in the receiver.

The above system allows conditional access to receive information where no unique communication paths can otherwise be established with the transmitter of the information, i.e. where the system is a broadcast system such as a digital radio broadcast. The user requires no technical knowledge or learning to establish or change the access conditions, and the actions the user is required to take are minimal and simple to understand. The operation of the invention is identical whatever the number and complexity of access conditions being established or modified. Changing of the access conditions is robust and secure.

In a preferred embodiment of the invention, the system of the invention provides the receiver with a system for controlling the delivery of speech synthesised text to allow a user to navigate through a document or a publication formatted with the standard text-to-speech format of the invention, as described above in relation to FIGS. 1 and 2. There are many possible publications which could be delivered in digital form to a receiver, and the invention allows the user to use commands which are standardised between different publications.

FIG. 4 is an illustration of a system for controlling the delivery of speech synthesised text in accordance with an embodiment of the invention, which may be combined with each or any of the systems described in relation to FIGS. 1, 2 and 3 above and FIGS. 5 and 6 below.

A receiver comprises a system for controlling the delivery of speech synthesised text. In an embodiment, the receiver comprises a control unit 434 for the system for controlling the delivery of speech synthesised text. The control unit may be embodied in various different ways, including a control interface on the receiver, a separate control pad, which may be in-built into a steering wheel of a vehicle or attachable thereto, and which communicates with the receiver by short range link such as infra-red or Bluetooth radio, or an in-built multi-function control stick for providing commands to the system.

The control unit can include one or more buttons and/or control movements which operate switches mounted in the control unit. In response to operation of the switches, the control unit generates a series of standard commands which are sent to the receiver which enables the user to simulate the experience of reading a document, such as newspaper or a magazine, using synthesised speech. The control unit can also be used to control other audio equipment in a vehicle.

Where the control unit is a control stick, in response to the movement of the stick in different directions or planes, a switch is actuated to operate different commands in the control system. The control stick 434 shown in FIG. 4 has vertical movement in two opposite directions, 455 and 459, which simulates the movement in opposite directions in a document processed in the receiver. The control stick allows movement in two, pressure dependent tiers, a first tier corresponding to movement at a first level in the document, a second tier corresponding to movement at a second, different level in the document.

The first level corresponds to lighter pressure and preferably simulates movement backwards or forwards between paragraphs of an article, moving to the start of the first sentence of the previous or next paragraph. The second level corresponds to firmer pressure and preferably simulates the movement backwards or forwards between articles in the document. Where the control unit is a control pad, two corresponding levels of control can be implemented by, for example, a single click operation of a button and a double click operation of the button, respectively.

The control stick can also be moved forward 458 or backward 454. This simulates the movement between sections (pages or articles, depending on the current vertical level in the document the user has navigated to) within a document under the control of the user. Where the control unit is a control pad, corresponding control can be implemented by, for example, two buttons, one for each direction of movement between the sections, respectively.

The control stick also has a button on the end 456 which when actuated is used to stop and start replay, select or repeat items or to actuate “link-in” tags linking to another item. Where the control unit is a control pad, corresponding control can be implemented by a similar further button.

The control stick also has a twist knob 457 which is used to change the volume. Alternatively, volume control may be provided on the face of the receiver.

The control unit may also have another control movement, such as a firm pull of the control stick towards the steering wheel, or a separate button, to cause the current item to jump backwards in the text for a specified duration, for example to replay the previous fifteen seconds of text.

Alternatively, the control unit may include a microphone for receiving spoken commands which are processed by speech recognition software. The spoken commands may allow a user to perform the following functions: select the next or previous page or section or item; read out the headlines from the page it is on, the headlines being read out in sequential order; move to the previous or next headline; start reading the first paragraph from the item when on a headline; move to the previous or next paragraph within an item; replay item or repeats last, for example fifteen seconds; pause and start playing again; mark and store an item; replay stored items; adjust reading speed or changes voices; searches for particular items within the publication; hyperlink to another article after a prompt.

The speech recognition software could store the page titles for a document, such as “sports” or “international” and then match them to spoken commands, to allow the user to navigate directly to the page in question. A user may also define command preferences, which then can be stored for future use.

Any of the above mentioned functions may also be operated by a combination of inputs. The system allows a user to selectively control the reproduction of text documents or publications in speech form. Documents or publications can be reproduced in environments where the user is unable to read or where the user is visually impaired. The user need learn only one simple, intuitive command set which is common to all documents or publications being reproduced. The system is fully scaleable across all types and sizes of publications and languages.

In a preferred embodiment of the invention, the system includes a compliant dictionary system for automatically identifying new words in textual information intended for speech synthesis.

FIG. 5 is a schematic illustration of a compliant dictionary system in accordance with an embodiment of the invention, which may be combined with each or any of the systems described in relation to FIGS. 1, 2, 3 and 4 above and FIG. 6 below.

The compliant dictionary system 504 is used for automatically identifying new words in textual information intended for eventual speech synthesis. The system allows an operator to create new phonetic rules for them, then creating a document-specific phonetic dictionary within a data file containing text data for production in a receiver arranged in accordance with an embodiment of the invention. As described above, a print publication document, typically a daily newspaper page layout file, is received by a conditioning system arranged in accordance with an embodiment of the invention, and is passed over from a document format conversion system 503, which operates in a fashion similar to the document format conversion systems described in relation to FIGS. 1 and 2. The data is fed into a text separation system 561 which extracts a list of all of the words in the text data. It removes duplicates in order to create a list of all of the individual words that are in the document which it passes to the phonetic dictionary 562. The text separation system 561 then passes 565 the complete standardised data file to the dictionary embedding system 564. It also passes 566 a copy of the data file to the phonetic conditioning tool 567. The individual word list is received by the phonetic dictionary 562 where it is compared to all of the words listed in the dictionary. A non-compliant word list 569 of words not in the dictionary is created. The non-compliant word list is then sent to a phonetic transcription tool 567 where they are processed manually by an operator to ensure provide phonetic transcriptions of each non-compliant word, as, for example, an IPA Unicode file. First, an operator sees and hears the list of non-compliant words in the phonetic transcription tool 567 on a computer system. The operator can also see these words in the context in which they appeared in the original document because the phonetic conditioning tool has received the full document 566. The operator, by using a phonetic transcription tool, then manually creates the phonetic transcriptions of all of the non-compliant words, may check the sound of them within the context of the document and use means to confirm the correctness of the phonetic spelling or rules for new words in their contexts. The list of non-compliant words 573, along with their phonetic transcriptions is then sent 571 to the phonetic dictionary 562 where it is used to produce a document-specific non-compliant word list with phonetic transcriptions. This word list is then sent 563 to the phonetic transcription appending system 564 where it is combined with the standardised data file to produce an output file in a document-independent and language-independent format which includes all of the information necessary for the document to be used in a device which uses a compliant TTS engine.

The phonetic transcriptions may be sent back to the document format conversion system 503 for review prior to delivery to the transmission system for onward transmission to a receiver.

The compliant dictionary system is advantageous in that words which have not been used before appearing in the text can immediately be identified and phonetic transcriptions or rules created for them. The remote receivers do not need to hold phonetic transcriptions for all words, nor try to pronounce words which is does not hold transcriptions for, but can store a limited dictionary holding transcriptions for only compliant words, and receive additional transcriptions as and when they appear in documents which are being received. No updating of the dictionary or phonetic rules is required in the receivers. The system is fully scaleable across size and spoken languages, and the standardised document-independent and language-independent format in which the data is transmitted means that any document can be processed and handled regardless of size or format.

In a preferred embodiment, the system of the present invention comprises a data conditioning system as mentioned above. Documents are typically and traditionally published through print, although modern practice for print publications now includes creating different versions for internet publication. Almost all publishers create text-based documents for a print version first, then adapt for other media as required. The print documents so created include metadata, defining, for example, the size of headlines and the positioning of articles on pages. However, this metadata is of limited value in defining the attributes needed for non-visual published versions of the information, such as a spoken version which simulates the experience of reading a publication whilst the user is unable to read, for example whilst driving.

In order to increase the value to a publisher who wishes to publish information prepared for a print format in a non-visual form, such metadata can be removed or modified and combined with other necessary speech-related data in order to be able to create a non-visual publication. The mere creation of such data is not, however, of value to a publisher on its own, since the publication would then require a specialised device to reproduce the publication in non-visual form.

FIG. 6 is a schematic illustration of a data conditioning system in accordance with an embodiment of the invention, which may be combined with each or any of the systems described in relation to FIGS. 1, 2, 3, 4 and 5 above.

In the data conditioning system 602, a text file 601 is extracted from the workflow of a publication, such as a newspaper, as it goes to print on a daily basis. The publication may be in a format which includes tagging for such elements as page titles, headlines, font, sentence and paragraph descriptors. The text file is conveyed to a “publication independent structure” converter 675 where a standard series of tags are applied to the data, for example ranking articles on a page in order of importance according to a set of rules, identifying sections and editions. This text is conveyed to a “publication specific structure” converter 676 where a publication specific series of tags are applied to the data. This is for instance information that has been modified and stored by the publisher for that specific publication. The converters 675 and 676 may operate in a fashion similar to the document format converter 103 described in relation to FIG. 1, except that the general conversion rules and the publication-specific conversion rules are applied in this case separately by the different converters 675, 676 respective.

An operator is able to see and hear the results of this tagged publication using a computer based analysis and setting system 677 and a user interface (not shown) for manually editing the tags. The system interacts with a compliant dictionary language system 604, as described in relation to FIG. 5, which generates a phonetic dictionary and other language rules specific to a particular edition into the edition specific structure stage 679 which the operator or publisher editorially reviews the document possibly in non-visual and possibly visual format, by editing the tags and text to produce different simulated reading effects and to refine the user experience for a particular edition. Consequently, data in a standardised format including a particular edition of a publication is transferred to a file combination system 679. The analysis and setting system 677 is also used to edit a configuration file 680 which controls the presentation of a publication and how the user experiences the publication, for example how the publication refreshes or stores editions or whether and how it deals with inserted data, such as news flashes. The configuration file 680 can also be edited manually on a publication or edition basis. It is combined with the data in the standardised format in the file combination system 679. The analysis and setting system 677 is also used to manage and access a stored digital audio, text or hybrid audio/text file database 623. This could be used for example to provide audio or audio/text advertisements. The analysis and setting system 677 is used to select, manually for instance, any audio or hybrid audio/text files and determine the rules by which they are dealt with in a publication or an edition of a publication, for example in which circumstances an advertisement would be heard and how the user will experience it. The combined digital audio file and data configuration file 681 is then transmitted to the file combination system 679. The file combination system 679 outputs a single file in a completely standardised document-independent and language-independent form via a communication channel for feeding into a transmission system 605. The descriptive tagging used to control aspects of speech such as pronunciation, volume, pitch rate, is added using Speech Synthesis Markup Language (SSML).

There are also a few special independent aspects of the invention. In a first such aspect, a data conditioning system for non-visual document publication comprise a means of extracting data from documents intended for visual publication, a means of converting extracted data into a document-independent and language-independent standardised format, a means of adding descriptive tagging for non-visual reproduction of the document, a means of allowing editorial review of the document in non-visual format, and a means of creating an output file in a further document-independent and language-independent standardised format.

In a second independent aspect of the invention, a system and a method for dynamically identifying new words in textual information intended for speech synthesis, automatically identifying new words and allowing an operator to create new phonetic rules for them, then creating a document-specific phonetic dictionary within a data file for onward transmission in a standardised format, comprise a means of separating a text stream intended for speech synthesis into known and new words, a means of allowing an operator to dynamically create phonetic rules for new words and add them to a phonetic dictionary, a means of allowing an operator to confirm the correctness of the phonetic rules for new words in their contexts, a means of embedding the phonetic rules required for a specific document into a document-independent and language-independent data format for onward transmission.

In a third independent aspect of the invention, a system and a method for controlling the delivery of speech synthesised from text to allow a user to simulate the reading of a document or a publication, comprise a method of allowing portions of the text to be selectively reproduced under the control of the user by means of a multi-function control stick, and a standardised command set operated by the user.

In a fourth independent aspect of the invention, a system and a method for controlling the delivery of speech synthesised from text to allow a user to simulate the reading of a document or a publication, comprise a method of allowing portions of the text, which have had been marked with standardised tags, to be selectively reproduced under the control of the user by means a standardised command set operated by the user.

In a fifth independent aspect of the invention, a system and a method for controlling the delivery of speech synthesised from text to allow a user to simulate the reading of a document or a publication, comprise a method of allowing portions of the text, which have had been marked with standardised tags, to be selectively reproduced under the control of the user by means of a multi-function control stick, and a standardised command set operated by the user.

In a sixth independent aspect of the invention, a system and a method for tagging and transferring text documents over radio waves to enable a user to simulate the experience of reading a document using synthesised speech, comprise a means of extracting data from a publisher's page layout files, a means of the addition of descriptive tags to such data, a means of including a set of document language rules, a means of converting data into a standardised format for transmission, a means of transmitting data to a receiver, a means of controlling the reproduction of the data by a user, and a means of converting the received data into speech.

In a seventh independent aspect of the invention, a system and a method of establishing or modifying conditions of access to information received electronically, comprise a telephone including a loudspeaker operated by a user to communicate with a telephone operator, a telephone operator able to communicate with the user and the telephone, a means of receiving electronic information to which access must be controlled, a means of access control which is dependent on externally set parameters, a microphone able to receive audible tones from the telephone, a means of generating an identical unique parameter at the location of the telephone operator and the information receiving device and of comparing the independently generated unique parameters.

The various different embodiments of data conditioning system of the invention are advantageous in that data received from a multiplicity of sources in different document formats, can be converted by adds descriptive tagging for non-visual reproduction in a document-independent and language-independent standardised format, allowing editorial review and editing in the non-visual format, and creating an output file in a further document-independent and language-independent standardised format, ready for output by a non-visual document reproducing system. A publisher wishing to publish in a non-visual format can use existing print-related publication files to create a non-visual publication, subject to his own styles and editorial controls, and ensure that the audio output content is of a high quality.

The above embodiments are to be understood as illustrative examples of the invention. Further embodiments of the invention are envisaged. The text documents may also incorporate known encryption and digital rights management (DRM) functionality to protect confidentiality and copyright as appropriate.

In another embodiment, the receiver can also accept geographical location defining data, for example from a satellite positioning system and deliver information from a document based on the location of the receiver. For example a tour guide document formatted in the standardised format of the invention and received from a broadcast transmission or ported in from another source, and parts of the document could be delivered in response to the location of the user changing. For example, in the example where the receiver is mounted in a vehicle, the information can be delivered appropriate to the location of the vehicle, as determined for example by an on-board Global Positioning System (GPS) receiver, and as the user is driving, relevant items of interest could be described from the tour guide document. In this respect, the receiver acts as an output device which can navigate through the tour guide document at least partly automatically, as the vehicle is navigated in the real world.

In another alternative embodiment, a data conditioning system may be provided in the form of a simplified desktop tool for “wrapping” documents that have been previously produced in a standard word processing file format, or other document formats such as the Portable Document Format (PDF).

In an alternative embodiment, the receiver may not include a compliant phonetic dictionary. In such a case, for each publication a phonetic transcription is provided for each of the words included in the text data. The data conditioning system adds the phonetic transcription of each of the words to the text data, the added phonetic code being in the form of a document-specific phonetic dictionary for instance, which is then transmitted to the receiver. The receiver looks up the phonetic transcription of all words from the added phonetic code in the received data.

In another embodiment, the conditioning system may or may not include a compliant phonetic dictionary and may consult a remote language analysis knowledge database, e.g. comprising a phonetic master dictionary, to which the conditioning system is linked. The receiver may or may not include a compliant phonetic dictionary.

Note that, in the above embodiments, the print publication format is a page layout file format. However, other print publication formats, such as word processor document formats, may be used as inputs to the system. Also, other formats produced as outputs from the print publication process such as print publication archiving formats and print publication syndication formats and print publication internet formats may be used as inputs to the system.

Note that, in the above embodiments, the standardised text-to-speech format includes text coded in the form of words formed by alphabetical characters for rendition by a text-to-speech engine. Other coding of text may be alternatively used in the standardised text-to-speech format, for example a phonetic representation of the text. However, text coded in the form of words formed by alphabetical characters is preferred for compactness of the data.

Note further that, whilst in the above embodiment the data conditioning system is located at a single site, the data conditioning system may be distributed between different sites. In particular, some parts of the data conditioning system, such as the pre-conditioning system, may be located at publisher sites.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A system for distributing a text document comprising: a data conditioning system including:
a data receiver for receiving the text document in a received document format; and
a conversion system for converting the text document from the received document format to text data in a standardized text-to-speech format; and
a transmission system for transmitting the text data in the standardized text-to-speech format,
whereby a receiver, including a text-to-speech converter, can be used for converting the text data into speech.

2. A system according to claim 1, wherein the received document format is a page layout file format.

3. A system according to claim 1, wherein the conversion system is adapted for converting data extracted from documents having a plurality of different print publication formats to text data in said standardized text-to-speech format.

4. A system according to claim 1, wherein the data conditioning system comprises a system operative to insert tags in the text data.

5-6. (canceled)

7. A system according to claim 1, wherein the data conditioning system comprises a system operative to append phonetic code to the text data in the standardized text-to-speech format.

8-11. (canceled)

12. A system according to claim 1, wherein the data conditioning system comprises an analysis and setting system operative to form a configuration file controlling the presentation of the text data.

13. (canceled)

14. A system according to claim 1, wherein the data conditioning system comprises a system operative to add an audio and/or text and/or image file to the data in the standardized text-to-speech format.

15-22. (canceled)

23. A system according to claim 1, wherein the transmitter is set up for one-to-many transmission.

24. (canceled)

25. A system according to claim 1, further comprising a receiver, including a text-to-speech converter, for converting the text data into speech.

26. (canceled)

27. A system according to claim 25, wherein the receiver comprises a compliant phonetic dictionary.

28-35. (canceled)

36. A system according to claim 25, wherein the receiver comprises a system for controlling the delivery of speech synthesized text by performing navigation within said text data.

37-47. (canceled)

48. A method of distributing a text document, comprising the steps of:
receiving the text document from a print publication process;
converting the text document to converted data in a standardized format, the conversion process comprising inserting markup for assisting navigation between parts of the document when said parts are output as speech; and
transmitting the converted data in the standardized format,
whereby a receiver, including an audio output device, can be used for outputting the converted data as speech and for navigating between said parts of the document when those parts are output as speech.

49. A method according to claim 48, including the step of adding tags to text from the text document.

50. A method according to claim 49, including the step of forming phonetic code pertaining to the text.

51-53. (canceled)

54. A method according to claim 48, including the step of forming a configuration file controlling the presentation of the converted data.

55. A method according to claim 48, including the step of adding an audio and/or image and/or text file to the data in the standardized format.

56. (canceled)

57. A method according to claim 48, including the step of converting the received data to speech by synthesizing speech.

58. (canceled)

59. A method according to claim 48, wherein the conversion makes use of a compliant phonetic dictionary contained in the receiver.

60-63. (canceled)

64. A method according to claim 48, including the step of controlling the delivery of speech synthesized text by the receiver.

65-71. (canceled)

72. An output device for outputting speech by text-to-speech synthesis, wherein the output device is adapted to receive a document in a standardized text format, and to navigate through the document in response to the receipt of geographical location data.

73. (canceled)
